(19) United States
(12) Patent Application Publication
(10) Pub. No.: US 2023/0104028 A1
(43) Pub. Date: Apr. 6, 2023

(54) SYSTEM FOR FAILURE PREDICTION FOR INDUSTRIAL SYSTEMS WITH SCARCE FAILURES AND SENSOR TIME SERIES OF ARBITRARY GRANULARITY USING FUNCTIONAL GENERATIVE ADVERSARIAL NETWORKS

(71) Applicant: Hitachi, Ltd., Tokyo (JP)

(72) Inventors: Qiyao Wang, Los Gatos, CA (US); Haiyan Wang, Fremont, CA (US); Chetan Gupta, San Mateo, CA (US)

(21) Appl. No.: 17/494,662

(22) Filed: Oct. 5, 2021

(51) Int. Cl. G05B 23/02; G05B 13/04; G05B 13/02

(52) U.S. Cl. CPC G05B 23/0283; G05B 23/0221; G05B 23/024; G05B 13/048; G05B 13/027

(57) ABSTRACT

Systems and methods described herein can involve executing a functional generator configured to generate multivariate continuous sensor curves from training with arbitrary multivariate sensor data with irregular timestamps received from one or more apparatuses; executing a functional discriminator to discriminate the generated multivariate continuous sensor curve from the arbitrary multivariate sensor data; and for the functional discriminator discriminating the generated multivariate continuous sensor curve from the arbitrary multivariate sensor data with irregular timestamps, providing feedback to the functional generator to retrain the functional generator.

### BACKGROUND

### Field

The present disclosure is generally directed to industrial systems, and more specifically, to functional generative adversarial networks for industrial systems.

### Related Art

The past several decades have witnessed the emergence of the Industrial Internet-of-Things (IIoT) across many industries including manufacturing, logistics, energy, mining, oil, and gas. By leveraging the automation in data collection from interconnected sensors, cloud computing-based data storage and exchange, and advanced data analytics, IIoT provides smart digital solutions that empower wise decision making, which can facilitate improvements in many aspects, such as productivity, product quality, operational efficiency, and financial sustainability.

In the Industrial IoTs, there are typically different sorts of artificial intelligence (AI) based systems that generate data-driven insights in real time. One such type of system is the failure prediction system. The goal of a failure prediction system is to predict incoming failures (i.e., production failure that results in higher than expected product defect rate, industrial equipment failure) before they occur so that the factories can take proactive actions to contain the impact of failures and potentially prevent the failures. Mathematically, this goal is often achieved by building a valid mathematical mapping from the sensor data over a historical period that captures the past conditions or behaviors of shop floors to the corresponding probability of failures.

Probability of incoming failures=F(sensor data over a period)

For instance, failure prediction systems for early product defect detection are powered by a backend AI model that predicts the probability of a product being defective in the final quality test, given sensor data at the early stage of manufacturing. As another example, failure prediction systems for industrial equipment employ data analytics models to predict the probability of not performing as desired within the next several days, based on sensor data from equipment up to the present.

To construct the AI models embedded in failure prediction systems, it is required to have multiple realizations of the operations and the corresponding outcome, e.g., the sensor data and the corresponding binary label that indicates whether a failure occurred for a set of product units. In general, these two sources of industrial data often exhibit the following characteristics:

1) Failures are scarce, due to the robustness of industrial systems. For instance, the defective rate of automotive parts is typically less than 0.5%.

2) The sensor data exhibit arbitrary granularity. As shown by FIG. 1, the number of observations and the timestamps associated with the observations are often different across sensors and equipment. Such irregularity and heterogeneity among sensor measurements are often introduced by missing data in the data recording or exchanging process or the random data capturing mechanism among many IoT systems.

3) Sensor data exhibit complex temporal patterns within each sensor and temporal covariations among different sensors, due to the mechanism of physics systems and the connectivity of components within industrial systems.

In practice, the task of building a failure prediction model with scarce failure units and sensor time series of arbitrary granularity is accomplished in two steps. First, data balancing techniques are implemented to get a comparable amount of failure and non-failure data instances (i.e., products or equipment). Second, a failure prediction model that maps sensor time series to the probability of an incoming failure is built upon the achieved data in the first step. Ideally, in both steps, the data analytic techniques should appropriately 1) handle the irregularity among sensor time series and 2) account for the temporal pattern and covariations among sensor data.

For the task in the first step, there are three existing types of data-balancing approaches whose limitations can be summarized as follows. First, the re-sampling techniques that either natively generates multiple copies of failure data instances (i.e., increase the number of failure units) or randomly removes a certain proportion of non-failure instances (i.e., reduce the amount of non-failure units) is not the optimal type of solutions for data balancing purposes. This type of technique is known to introduce the risk of overfitting or removing valuable information, both of which have negative impact on the model accuracy. That means that the achieved model might miss an incoming failures or generate false positive warnings under healthy conditions. The second type is the cost sensitive learning in AI. These approaches directly use the provided imbalance data (i.e., do nothing in the first step) and reply on a modified cost function to draw more attention to the less represented failure units when building AI models. The main drawback is that it typically requires a deep understanding of the domain to design a valid cost function that renders an accurate failure prediction model. The last type of technique is the existing Generative Adversarial Network (GAN) models for time series data, including C-RNN-GAN, RC-GAN, TimeGAN, T-CGAN. These GAN architectures are deployed to study the statistical characteristics of sensor data prior to actual failures and synthesize more failure data instances that follow the same underlying dynamics.

The GAN-based approaches are often superior to the previous data balancing techniques. However, the existing time series GAN models cannot handle time series data of arbitrary granularity. This is because the sequential deep learning model-based components in these time series GAN require all the sensors across all equipment/products to be accessible at the same equally spaced resolution (i.e., every five minutes, daily, weekly). Furthermore, these sequential model-based GAN techniques cannot completely account for the temporal correlations and covariations, as sequential modeling techniques only account for the ordering among sensor measurements in the time series rather than the actual timestamps of the observations.

For the task in the second step, the sparse Functional Neural Network (sparse FNN) possesses the advantages in handling irregularity and the intrinsic temporal patterns among sensor time series, in comparison to other time series predictive models including the traditional classification and the sequential deep learning models. In the related art sparse FNN implementations, researchers often select to use one type of basis functions to project the information in sensor time series to a lower-dimensional space. The selection of basis functions affects model performance, and it is often determined by insights on the data provided by researchers.

### SUMMARY

The scarcity in failure units, the arbitrary granularity in sensor time series, and the complex temporally entangled patterns raise challenges and make existing AI models infeasible for building valid and reliable failure prediction systems. In example implementations described herein, there is a failure prediction system equipped with a new AI architecture that effectively and efficiently addresses these challenges.

In example implementations described herein, there is a proposed AI model that serves as the core algorithm within failure prediction systems in industrial IoTs. The proposed AI model consists of an innovative time series data balancing technique called the Functional Generative Adversarial Network (F-GAN) and a new failure predictive model called the Multi-Projection Functional Neural Network (MPFNN). To improve the automation in effective information capturing when conducting functional data analysis, the MPFNN utilizes multiple types of basis functions that cover various sorts of sensor data.

Compared to the related art, F-GAN and MPFNN appropriately and efficiently handle the irregularity among sensor time series and account for the temporal pattern and covariations among sensor data, due to the following features.

F-GAN is a proposed data balancing technique that involves a functional generator and a functional discriminator, where the generator produces synthetic sensor data corresponding to failure events and the discriminator detects the fake data from the sensor data of actual failures. These two components are trained simultaneously against the error of the discriminator in distinguishing fake data from real data, until the error is maximized (i.e., the discriminator cannot tell the difference between fake and real data). The functional generator utilizes the sparse multivariate Functional Principal Component Analysis (FPCA) and the Best Linear Unbiased Estimation (BLUE) technique to handle sensor data with arbitrary granularity and account for the temporal patterns. The functional generator further uses a fully connected neural network structure to generate continuous time series data following complex temporal distributions from scalar random noise and the continuous temporal patterns extracted from the irregular failure sensor signals by FPCA. The functional discriminator is capable of handling the irregularity and temporal aspects within sensor data through the idea of basis projection and the BLUE technique. The functional discriminator enables F-GAN to generate high-quality sensor time series, as it uses the MPFNN to enhance the discriminator's capability of detecting various sorts of differences between real and fake failure data. This forces the functional generator to improve its capacity in resembling patterns among the real failure data.

MPFNN is a proposed failure predictive model building technique that is capable of handling the irregularity and temporal aspects within sensor data through the idea of basis projection and the BLUE technique. MPFNN tends to have improved failure prediction accuracy (i.e., generate failure warning alerts when and only when a failure is approaching) due to the usage of multiple types of basis functions to more comprehensively represent the failure and non-failure sensor data.

Aspects of the present disclosure can involve a method, which can involve executing a functional generator configured to generate multivariate continuous sensor curves from training with arbitrary multivariate sensor data with irregular timestamps received from one or more apparatuses; executing the functional discriminator to discriminate the generated multivariate continuous sensor curve from the arbitrary multivariate sensor data; and for the functional discriminator discriminating the generated multivariate continuous sensor curve from the arbitrary multivariate sensor data with irregular timestamps, providing feedback to the functional generator to retrain the functional generator.

Aspects of the present disclosure can involve a computer program, which can involve instructions including executing a functional generator configured to generate multivariate continuous sensor curves from training with arbitrary multivariate sensor data with irregular timestamps received from one or more apparatuses; executing the functional discriminator to discriminate the generated multivariate continuous sensor curve from the arbitrary multivariate sensor data; and for the functional discriminator discriminating the generated multivariate continuous sensor curve from the arbitrary multivariate sensor data with irregular timestamps, providing feedback to the functional generator to retrain the functional generator. The computer program and instructions may be stored on a non-transitory computer readable medium and executed by one or more processors.

Aspects of the present disclosure can involve a system, which can involve means for executing a functional generator configured to generate multivariate continuous sensor curves from training with arbitrary multivariate sensor data with irregular timestamps received from one or more apparatuses; means for executing the functional discriminator to discriminate the generated multivariate continuous sensor curve from the arbitrary multivariate sensor data; and for the functional discriminator discriminating the generated multivariate continuous sensor curve from the arbitrary multivariate sensor data with irregular timestamps, means for providing feedback to the functional generator to retrain the functional generator.

Aspects of the present disclosure can involve a management apparatus configured to manage one or more apparatuses, which can involve a processor configured to execute a functional generator configured to generate multivariate continuous sensor curves from training with arbitrary multivariate sensor data with irregular timestamps received from one or more apparatuses; execute the functional discriminator to discriminate the generated multivariate continuous sensor curve from the arbitrary multivariate sensor data; and for the functional discriminator discriminating the generated multivariate continuous sensor curve from the arbitrary multivariate sensor data with irregular timestamps, provide feedback to the functional generator to retrain the functional generator.

### BRIEF DESCRIPTION OF DRAWINGS

FIG. 1 illustrates an example of sensor data with arbitrary granularity.

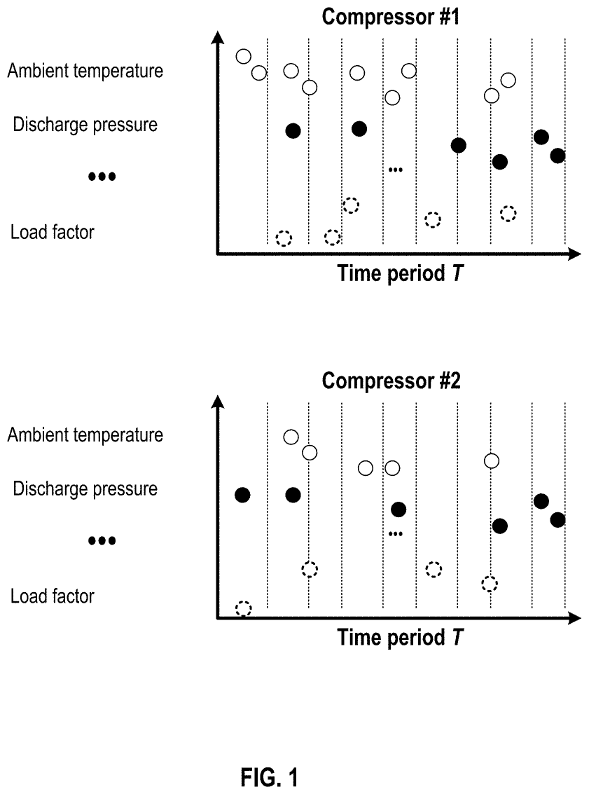

FIG. 2 illustrates an example flow diagram for the proposed failure prediction system for industrial equipment with scarce failures and irregularly observed sensor data.

FIG. 3 illustrates an example high-level architecture of the F-GAN, in accordance with an example implementation.

FIG. 4(A) illustrates the flow of the F-GAN building module, in accordance with an example implementation.

FIG. 4(B) illustrates an example flow of functional generator, in accordance with an example implementation.

FIG. 4(C) illustrates an example flow of functional discriminator, in accordance with an example implementation.

FIG. 5 illustrates an example flow of the new failure data generating module, in accordance with an example implementation.

FIG. 6 illustrates an example flow of the failure prediction model building module, in accordance with an example implementation.

FIG. 7 illustrates an example flow of the data-driven predictive model applying module, in accordance with an example implementation.

FIG. 8 illustrates a system involving a plurality of physical systems networked to a management apparatus, in accordance with an example implementation.

FIG. 9 illustrates an example computing environment with an example computer device suitable for use in some example implementations.

### DETAILED DESCRIPTION

The following detailed description provides details of the figures and embodiments of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Embodiments as described herein can be utilized either singularly or in combination and the functionality of the embodiments can be implemented through any means according to the desired implementations.

Example implementations propose a novel data-driven model-based system to calculate the probability of approaching failures and transmit failure prediction recommendations. The proposed system can involve the following components. Data collection and data storage units collect historical sensor data, and failure/non-failure label data indicated by past failure records. Further, it supplies streaming sensor data for real-time applications. Data-driven predictive model building units fits historical data by the proposed Functional Generative Adversarial Network (F-GAN) and the Multi-Projection Functional Neural Network (MPFNN) to build a predictive model that generates estimations on the probability of failures based on historical sensor time series data. Model deploying units deploy the learned model on streaming data to produce and transmit real-time data-driven recommendations. In example implementations described herein, the proposed AI architecture use F-GAN for data balancing and MPFNN for the failure prediction system.

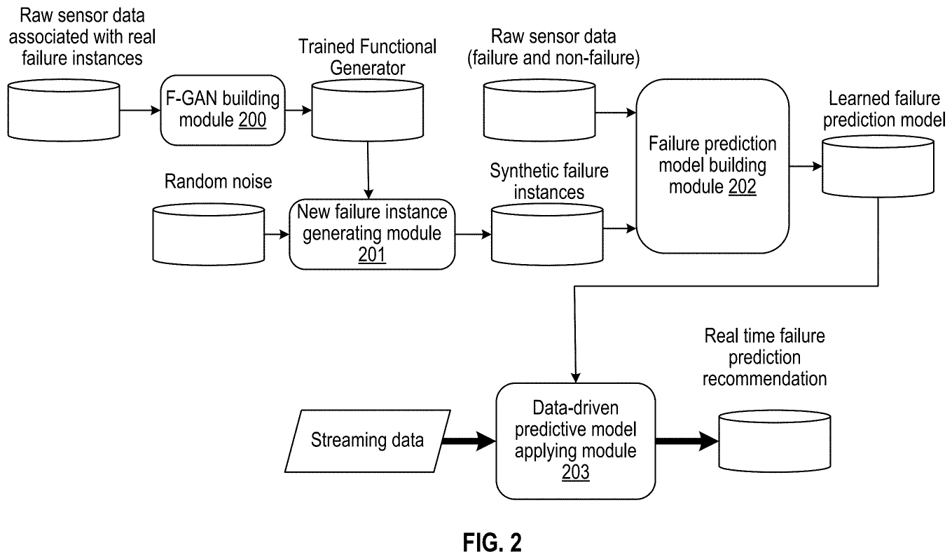

FIG. 2 illustrates an example flow diagram for the proposed failure prediction system for industrial equipment with scarce failures and irregularly observed sensor data. The proposed data-driven approach involves the following modules.

Functional Generative Adversarial Network building module 200 is where F-GAN is trained with raw historical sensor time series of failures to synthesize additional failure instances that follow the same dynamics with the observed failures in the form of a trained functional generator. New failure data instances generating module 201 intakes random noise and employs the trained functional generator to produce sensor data that resembles the statistical dynamics of historical failure instances. Failure prediction model building module 202 takes the generated failure instances from functional generative adversarial network building module 200 and new failure data instances generating module 201, and the raw historical data (both failure and non-failure) as the training data to build the learned failure prediction model. The performance of the achieved model is in general better than the model built using the historical data directly, because of the mitigation in the degree of imbalance. Data-driven predictive model applying module 203 conducts the applying phase. The learned failure prediction model in failure prediction model building module 202 is utilized to obtain the estimated probability of incoming failures given the streaming sensor time series received from underlying systems.

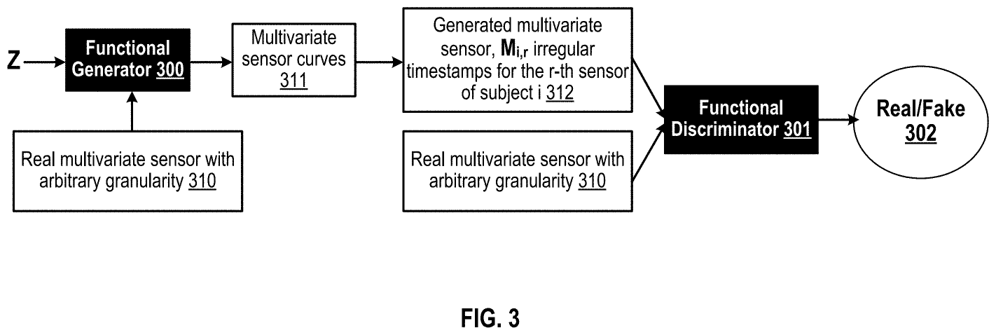

FIG. 3 illustrates an example high-level architecture of the F-GAN, in accordance with an example implementation. As a generative model, the proposed approach solves the data imbalance issue by generating ‘realistic’ operational time series of defect products. ‘Realistic’ means that the distribution of the generated sensor data is indistinguishable from the actually-observed sensor data.

As illustrated in FIG. 3, the high-level architecture of the F-GAN involves executing a functional generator 300 configured to generate multivariate continuous sensor curves 312 from training with arbitrary multivariate sensor data with irregular timestamps 310 received from one or more apparatuses; executing a functional discriminator 301 to discriminate the generated multivariate continuous sensor curves from the arbitrary multivariate sensor data; and for the functional discriminator 391 discriminating the generated multivariate continuous sensor curves 312 from the arbitrary multivariate sensor data with irregular timestamps 310, providing feedback 302 to the functional generator to retrain the functional generator 300.

In the F-GAN, a functional generator 300 maps scalar-valued random noises Z and real multivariate sensor with arbitrary granularity 310 to multivariate correlated continuous sensor curves 311 that follow a complex statistical distribution. Next, these generative curves are evaluated at timestamps generated by the timestamp generator at 312 to generate a multivariate sensor data having irregular Mi,r timestamps for the r-th sensor of subject i.

In the F-GAN, the sparse functional neural network is used as the functional discriminator 301 that tries to distinguish between the generated sensor data 312 with the real sensor time series 310 and makes a real/fake determination 302.

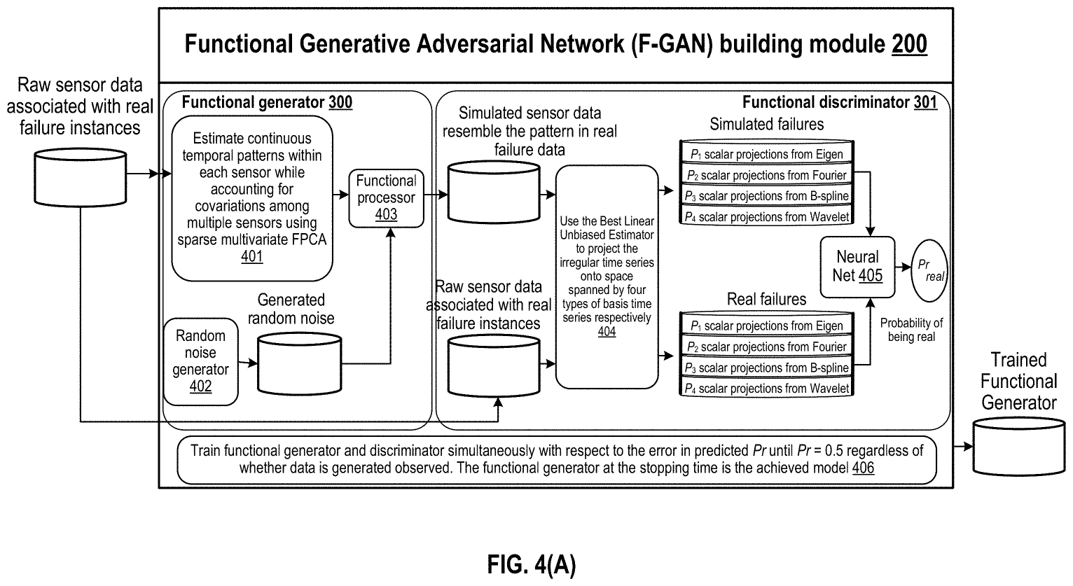

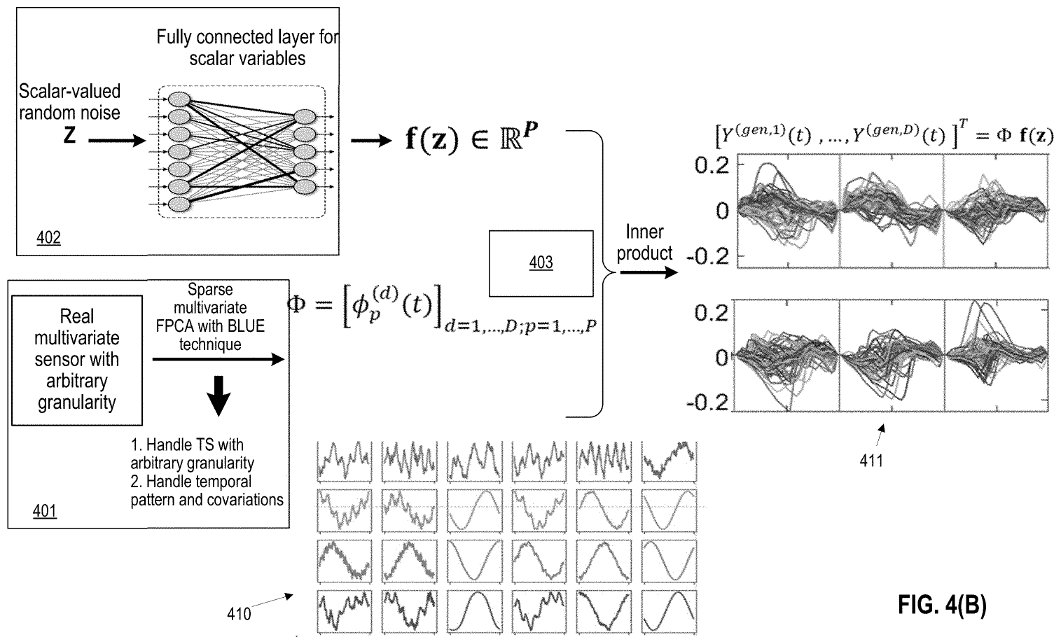

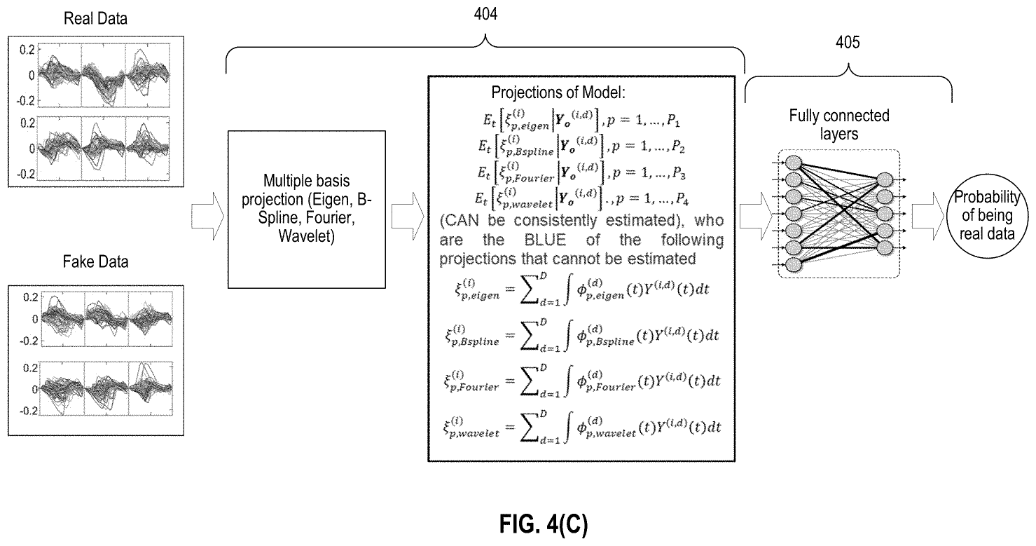

FIG. 4(A) illustrates the flow of the F-GAN building module 200, in accordance with an example implementation. The input of the F-GAN building module 200 is the irregularly observed sensor time series data of failure instances in the historical data set. The output of the module is the optimized functional generator that is capable of producing sensor time series resembling those of real failure data. The flow involved is described as below.

For the functional generator 300, the flow at 401 to 403 renders a functional generator that generates continuous random curves that follow the same stochastics as the actual failures. Such a functional generator 300 has the following features: handles time series data with arbitrary granularity; handles temporal pattern and covariations; generates time series data with complex distributions for industrial systems; and generate continuous curves to hold the full temporal characteristics of sensor data.

At 401 the raw sensor data is supplied into the sparse multivariate FPCA to extract continuous temporal patterns. These continuous temporal patterns represent the major modes of variation among sensor data corresponding to failure events. For instance, one of the obtained signals might be a linearly increasing curve. This indicates that the raw sensor data exhibits an increasing trend prior to a failure. This analysis handles the arbitrary granularity among sensor data and accounts for the temporal patterns and covariations.

At 402, a random noise generator is specified to generate scalar-valued random noise.

At 403, a functional processor first deploys the fully connected neural network to map the random noises into random variables following a complex statistical distribution with tunable parameters. Next, the functional processor combines the achieved random variable and the extracted patterns from 401 to produce new realizations of continuous time series that resemble the real sensor data corresponding to failures.

For the functional discriminator 301, the functional discriminator 301 distinguishes the generated data from the actual data, given the time series with arbitrary granularities. Such the functional discriminator 301 involves the following features: handle time series data with arbitrary granularity; handle temporal pattern and covariations; and generate high-quality sensor time series.

At 404, the synthetic and real sensor data corresponding to failure events are provided into the MPFNN-based functional discriminator that attempts to sort out the synthetic failure data. The sensor data of each instance is projected onto four types of basis functions, including eigen basis, Fourier basis, wavelet basis and B-spline basis. The projection is calculated based on the BLUE technique. In particular, the scalar-valued projections of the i-th data instance that encode Fourier-type temporal patterns of the d-th sensor data, for instance, are calculated by

$${\tilde{γ}}_{Fourier}^{( i , d )} = E [ {γ}_{Fourier}^{( i )} \vert {Y}^{( i , d )} ] = {( \frac{{Fourier , ( i , d )}_{}}{{σ}^{2}} + {B}_{Fourier , ( i , d )}^{T} {B}_{Fourier , ( i , d )} )}^{- 1} {B}_{Fourier , ( i , d )}^{T} {Y}^{( i , d )}$$

where [symbol] _{Fourier,(i,d)} is the covariance matrix of \tilde{Y}_{Fourier}^{(i,d)}, σ² is the standard error of random noises, Y^{(i,d)} is the irregularly observed sensor measurements from the d-th sensor data of the i-th unit, and B_{Fourier(i,d)}^{T} is the matrix that contain the irregular evaluation of the continuous Fourier basis functions at the discrete timestamps corresponding to the sensor measurements. The example implementation involves using multiple types of basis functions to enhance the ability of the function discriminator 301 to detect various sorts of differences between real and fake data, forcing the functional generator 300 to improve on the similarity between the generated data with the real failure data. At 405, the obtained scalar-valued projections are supplied into a fully connected neural network to non-linearly transform to the projections to the target real/fake label (equivalently, the probability of being real failure data). At 406, all the parameters in the above procedures are trained to solve the following min-max problem with objective function

$${min}_{FG} {max}_{FD} \{ {E}_{{X}_{real} ( t )} [ log FD ( {X}_{real} ( t ) ) ] +$$

$${E}_{z} [ log ( 1 - FD ( {X}_{sythetic , z} ( t ) ) ) ] \} {X}_{sythetic , z} ( t ) = FG ( z )$$

where ‘FG’ and ‘FD’ are respectively the functional generator 300 and functional discriminator 301.

FIG. 4(B) illustrates an example flow of functional generator 300, in accordance with an example implementation. The functional generator 300 is configured to generate continuous random curves that follow the same stochastics as the actual failures. The functional generator 300 is configured to handle time series with arbitrary granularity through sparse multivariate FPCA, handle temporal pattern and covariations through sparse multivariate FPCA, generate time series involving complex distributions for industrial systems through fully connected layers to map random noise z, and generate continuous curves to hold the full temporal characteristics of sensor data.

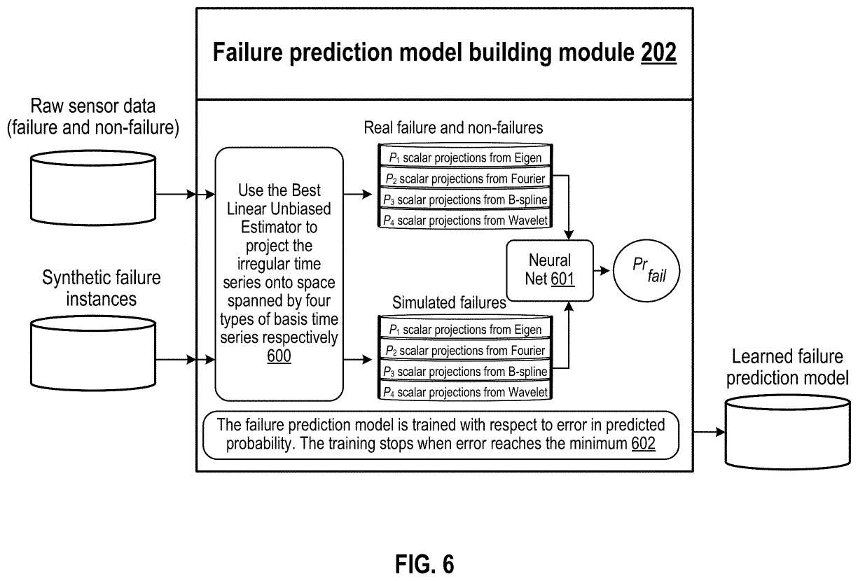

As illustrated in the flow of FIG. 4(B) in conjunction with the flow of FIG. 4(A), at 401, the real multivariate sensor with arbitrary granularity is processed with a sparse multivariate FPCA with the BLUE technique, further details of which are provided with respect to FIG. 6. The sparse multivariate FPCA with the BLUE technique can handle time series with arbitrary granularity and handle temporal pattern and covariations. Such a technique will produce D*P data-driven basis functions, of which the number of sensors is D and the number of basis per sensor is P, that holds the temporal pattern and correlations among multivariate time series as illustrated in the graph 410 of FIG. 4(B), arranged in order of sensor and eigen basis, as represented in the equation below:

Φ=[ϕₚ^{(d)}(t)]_{d=1, . . . , D;p=1, . . . , P}

With respect to the random noise generator 402, scalar-valued random noise z is provided through a fully connected layer for scalar variables to generate variables f(z) of complex distribution, or:

f(z)∈ [symbol] ^{P}

The results are processed by the functional processor 403 to take an inner product to generate continuous random curves over time of complex distribution as illustrated by the curves 411. The curves capture the randomness continuously over time t and can be used for problems with arbitrary granularities

FIG. 4(C) illustrates an example flow of functional discriminator 301, in accordance with an example implementation. The functional discriminator 301 distinguishes the generated data from the actual data, given the time series with arbitrary granularities. The functional discriminator 301 can be configured to handle time series data with arbitrary granularity through sparse multivariate FPCA, handle temporal pattern and covariations through the basis projection idea, and enable the F-GAN to generate high-quality sensor time series. In example implementations, the use of multiple types of basis functions enhances the ability of the functional discriminator 301 of detecting various sorts of differences between real and fake, forcing the functional generator improves the similarity between the generated data with the real failure data.

As illustrated in the flow of FIG. 4(C) in conjunction with the flow of FIG. 4(A), real data and fake data are provided for a multiple basis projection (e.g., eigen, B-spline, Fourier, Wavelet), and the multiple basis projection is specified to capture various sorts of temporal patterns and correlations. Real data involves sensor data of actual failures are in the form of time series data with arbitrary granularity. Fake data is the generated sensor data associated with failures by the functional generator 300 from FIGS. 4(A) and 4(B). The projections are calculated based on the BLUE technique for each set of basis functions so as to allow the F-GAN to generate the high-quality sensor time series. The projections are provided through fully connected layers that can thereby handle time series with arbitrary granularity and handle temporal pattern and covariations. The output of the fully connected layers is the probability of the data being actual data. Through the functional discriminator 301, the training of F-GAN can be completed and confidence can be obtained with respect to the quality of data generated by the functional generator 300, when the probability of being real data is 0.5 regardless of whether the data is real (i.e. observed data) or fake (i.e., generated by the functional generator).

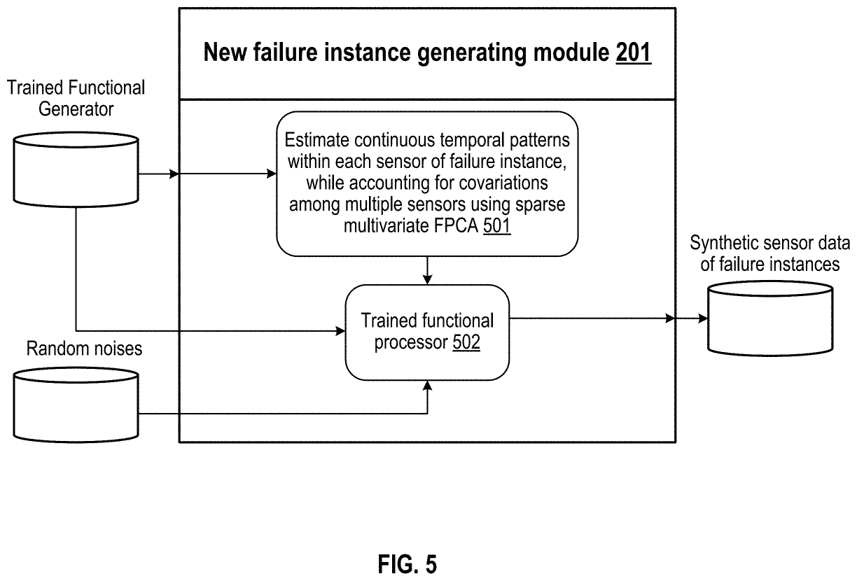

FIG. 5 illustrates an example flow of the new failure data generating module 201, in accordance with an example implementation. The inputs are the obtained trained failure data functional generator and the simulated random noise. The output of the module is the synthetic sensor time series that resembles the sensor time series of real failure data. The new failure data generating module 201 may have the following flow.

At 501, the module first loads the estimated continuous temporal pattern of failure data during the training of the functional generator and the trained functional processor into the system. At 502, the random noise generator is used to add randomness in the form of random noise. The extracted continuous temporal modes and the random noise that encode variation between data are thereby supplied into the configured functional processor to produce synthetic failure data.

FIG. 6 illustrates an example flow of the failure prediction model building module 202, in accordance with an example implementation. The input is the data set containing the synthetic failure instances, and the observed data instances. This new data set is more balanced than the raw data set in which there is much more non-failure data and a limited amount of failure instances. The output of the module is the trained failure predication model based on this data set. The failure prediction model building module 202 involves the following flow.

At 600, the sensor data of each instance is projected onto four types of basis functions, including eigen basis, Fourier basis, wavelet basis and B-spline basis. The projection is calculated based on the BLUE technique. In particular, the scalar-valued projections of the i-th data instance that encode Fourier-type temporal patterns of the d-th sensor data, for instance, are calculated by

$${\tilde{γ}}_{Fourier}^{( i , d )} = E [ {γ}_{Fourier}^{( i )} \vert {Y}^{( i , d )} ] = {( \frac{{Fourier , ( i , d )}_{}}{{σ}^{2}} + {B}_{Fourier , ( i , d )}^{T} {B}_{Fourier , ( i , d )} )}^{- 1} {B}_{Fourier , ( i , d )}^{T} {Y}^{( i , d )}$$

where [symbol] _{Fourier,(i,d)} is the covariance matrix of \tilde{Y}_{Fourier}^{(i,d)}, σ² is the standard error of random noises, Y^{(i,d)} is the irregularly observed sensor measurements from the d-th sensor data of the i-th unit, and B_{Fourier(i,d)}^{T} is the matrix that contain the irregular evaluation of the continuous Fourier basis functions at the discrete timestamps corresponding to the sensor measurements.

At 601, the obtained scalar-valued projections are supplied into a fully connected neural network to non-linearly transform to the projections to the target failure/non-failure label (equivalently, the probability of having an approaching failure).

At 602, the failure prediction model is continuously trained with respect to error in predicted probability. The training stops when the error converges to a minimum.

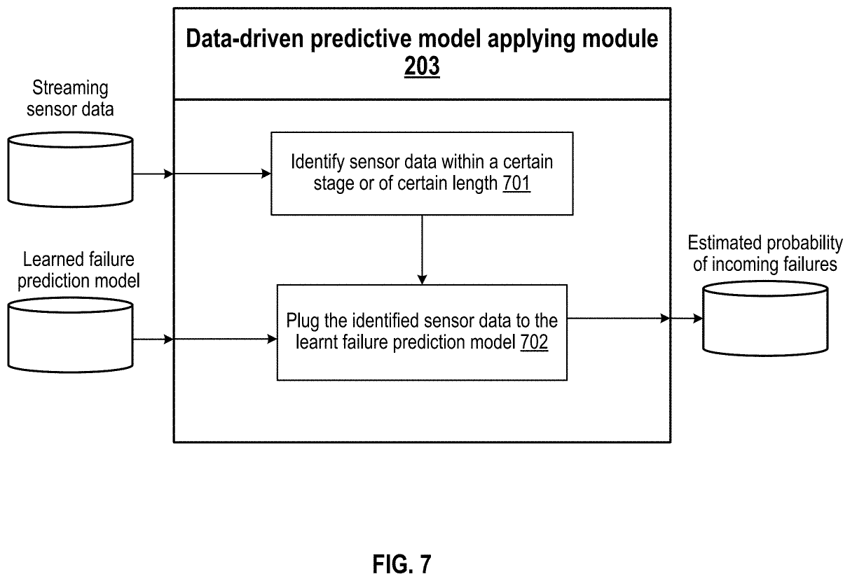

FIG. 7 illustrates an example flow of the data-driven predictive model applying module 203, in accordance with an example implementation. This module applies the learned failure prediction module to streaming sensor data to generate a real-time failure predication evaluation in the industrial IoT system. The flow when applying the learned model for streaming sensor data is as follows. At 701, a data preparer is triggered to identify and collect the sensor within the last M time units. Note that M is the length of period considered in the training phase. At 702, the prepared data are supplied into the configured failure prediction model to generate a real-time assessment on the probability of an incoming failure.

Through the example implementations described herein, failure prediction systems can be built with scarce failure data and irregularly observed sensor time series data. Compared to the related art implementations, the example implementations described herein tend to have better applicability and accuracy, due to the following reasons. All of the components, including the functional generator, the functional discriminator, and the MPFNN based failure prediction model, effectively handle the arbitrary granularity and complex temporal pattern in sensor data. The functional generator can produce realistic sensor data of complex statistical distributions, which widely occur in complicated industrial systems. The multiple projection idea in MPFNN enhances the capacity of differentiating real and fake data, as well as failure and non-failure data.

The proposed failure prediction system is valuable in a wide range of industries where generating warnings for incoming failures are essential for the business. Historical data further can have the following characteristics: scarce failure in the history, and sensor data is of arbitrary temporal granularity.

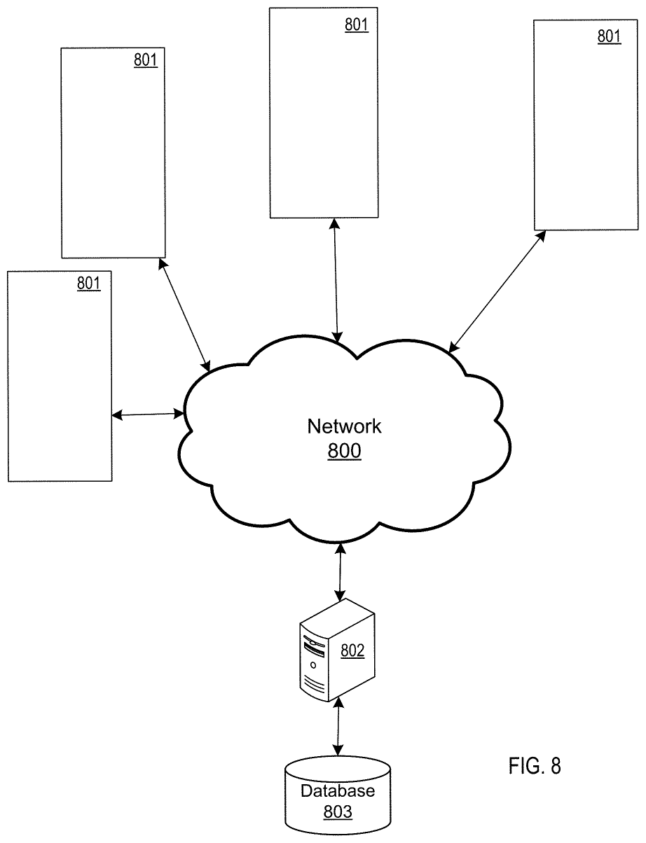

FIG. 8 illustrates a system involving a plurality of physical systems networked to a management apparatus, in accordance with an example implementation. One or more physical systems 801 are communicatively coupled to a network 800 (e.g., local area network (LAN), wide area network (WAN)), which is connected to a management apparatus 802. The management apparatus 802 manages a database 803, which contains historical data collected from the air compressors from each of the physical systems 801 and also facilitates remote control to each of the physical systems 801. In alternate example implementations, the data from the physical systems can be stored to a central repository or central database such as proprietary databases that intake data from air compressors, or systems such as enterprise resource planning systems, and the management apparatus 802 can access or retrieve the data from the central repository or central database. The one or more physical systems 801 can involve any kind of asset, apparatus, or physical systems that have sensor systems that can provide sensor data in an IoT environment, such as, but not limited to, edge sensor arrays, robotic arms, vehicles, lathes, air compressors, and so on in accordance with the desired implementation.

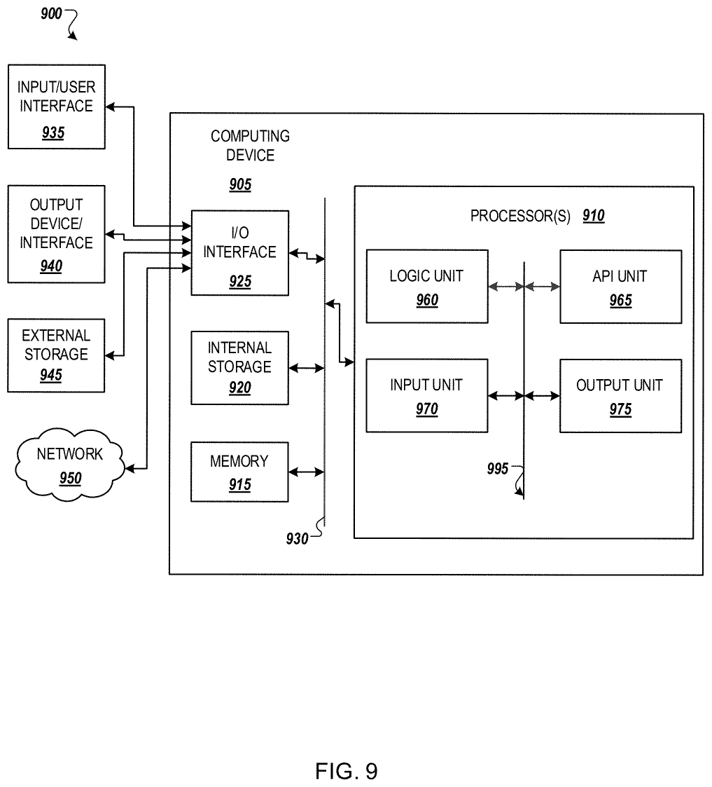

FIG. 9 illustrates an example computing environment with an example computer device suitable for use in some example implementations, such as a management apparatus 802 as illustrated in FIG. 8. Computer device 905 in computing environment 900 can include one or more processing units, cores, or processors 910, memory 915 (e.g., RAM, ROM, and/or the like), internal storage 920 (e.g., magnetic, optical, solid state storage, and/or organic), and/or I/O interface 925, any of which can be coupled on a communication mechanism or bus 930 for communicating information or embedded in the computer device 905. I/O interface 925 is also configured to receive images from cameras or provide images to projectors or displays, depending on the desired implementation.

Computer device 905 can be communicatively coupled to input/user interface 935 and output device/interface 940. Either one or both of input/user interface 935 and output device/interface 940 can be a wired or wireless interface and can be detachable. Input/user interface 935 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 940 may include a display, television, monitor, printer, speaker, braille, or the like. In some example implementations, input/user interface 935 and output device/interface 940 can be embedded with or physically coupled to the computer device 905. In other example implementations, other computer devices may function as or provide the functions of input/user interface 935 and output device/interface 940 for a computer device 905.

Examples of computer device 905 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 905 can be communicatively coupled (e.g., via I/O interface 925) to external storage 945 and network 950 for communicating with any number of networked components, devices, and systems, including one or more computer devices of the same or different configuration. Computer device 905 or any connected computer device can be functioning as, providing services of, or referred to as a server, client, thin server, general machine, special-purpose machine, or another label.

I/O interface 925 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 900. Network 950 can be any network or combination of networks (e.g., the Internet, local area network, wide area network, a telephonic network, a cellular network, satellite network, and the like).

Computer device 905 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 905 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C #, Java, Visual Basic, Python, Perl, JavaScript, and others).

Processor(s) 910 can execute under any operating system (OS) (not shown), in a native or virtual environment. One or more applications can be deployed that include logic unit 960, application programming interface (API) unit 965, input unit 970, output unit 975, and inter-unit communication mechanism 995 for the different units to communicate with each other, with the OS, and with other applications (not shown). The described units and elements can be varied in design, function, configuration, or implementation and are not limited to the descriptions provided. Processor(s) 910 can be in the form of hardware processors such as central processing units (CPUs) or in a combination of hardware and software units.

Processor(s) 910 can be configured to execute a functional generator configured to generate multivariate continuous sensor curves from training with arbitrary multivariate sensor data with irregular timestamps received from one or more apparatuses; execute a functional discriminator to discriminate the generated multivariate continuous sensor curves from the arbitrary multivariate sensor data; and for the functional discriminator discriminating the generated multivariate continuous sensor curves from the arbitrary multivariate sensor data with irregular timestamps, providing feedback to the functional generator to retrain the functional generator.

Processor(s) 910 can be configured to execute a functional generator configured to generate multivariate continuous sensor curves from training with arbitrary multivariate sensor data with irregular timestamps received from one or more apparatuses; execute a functional discriminator to discriminate the generated multivariate continuous sensor curves from the arbitrary multivariate sensor data; and for the functional discriminator discriminating the generated multivariate continuous sensor curves from the arbitrary multivariate sensor data with irregular timestamps, provide feedback to the functional generator to retrain the functional generator as illustrated in FIGS. 2, 3, 4(A) to 4(C), and 8. As described herein, the multivariate continuous sensor curves can be representative of failure data of the one or more apparatuses of FIG. 8.

Depending on the desired implementation, the functional generator is configured to apply sparse multivariate functional principal component analysis (FPCA) on the arbitrary multivariate sensor data with irregular timestamps to generate the multivariate continuous sensor curves while maintaining full temporal characteristics of the arbitrary multivariate sensor data with the irregular timestamps as illustrated in FIGS. 4(A), 4(B), and 6.

Depending on the desired implementation, the functional discriminator is configured to specify multiple basis projection functions to capture temporal patterns and correlation of the generated multivariate continuous sensor curve and the arbitrary multivariate sensor data with irregular timestamps as illustrated in FIGS. 4(A) and 4(C). For example, the functional discriminator can be configured to calculate projections based on a linear unbiased estimator for each set of the multiple basis projection functions, such as the BLUE technique. However, other linear unbiased estimators can be used beside the BLUE technique, and the present disclosure is not limited thereto.

Depending on the desired implementation, the functional generator is configured to load an estimated continuous temporal pattern of failure data during training of the functional generator into a functional processor; execute a random noise generator to provide random noise into the functional processor; and produce synthetic failure data from the functional processor based on the estimated continuous temporal pattern of failure data and the random noise as illustrated in FIGS. 2, 4(A), 4(B) and 6.

Processor(s) 910 can be configured to generate a functional neural network against training the trained functional generator to create a failure prediction model as illustrated in FIGS. 2, 3, 4(C), and 7. Processor(s) 810 can then execute the failure prediction model on the one or more apparatuses to detect real-time failures of the system of FIG. 8 and as illustrated in FIG. 2.

In some example implementations, when information or an execution instruction is received by API unit 965, it may be communicated to one or more other units (e.g., logic unit 960, input unit 970, output unit 975). In some instances, logic unit 960 may be configured to control the information flow among the units and direct the services provided by API unit 965, input unit 970, output unit 975, in some example implementations described above. For example, the flow of one or more processes or implementations may be controlled by logic unit 960 alone or in conjunction with API unit 965. The input unit 970 may be configured to obtain input for the calculations described in the example implementations, and the output unit 975 may be configured to provide output based on the calculations described in example implementations.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In embodiments, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Embodiments may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the embodiments are not described with reference to any particular programming language. It will be appreciated that a variety of programming languages may be used to implement the teachings of the embodiments as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the embodiments may be implemented using circuits and logic devices (hardware), while other aspects may be implemented using instructions stored on a machine-readable medium (software), which if executed by a processor, would cause the processor to perform a method to carry out implementations of the present application. Further, some embodiments of the present application may be performed solely in hardware, whereas other embodiments may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other embodiments of the present application will be apparent to those skilled in the art from consideration of the specification and practice of the teachings of the present application. Various aspects and/or components of the described embodiments may be used singly or in any combination. It is intended that the specification and embodiments be considered as examples only, with the true scope and spirit of the present application being indicated by the following claims.

What is claimed is:

1. A method, comprising:
executing a functional generator configured to generate multivariate continuous sensor curves from training with arbitrary multivariate sensor data with irregular timestamps received from one or more apparatuses;
executing a functional discriminator to discriminate the generated multivariate continuous sensor curves from the arbitrary multivariate sensor data; and
for the functional discriminator discriminating the generated multivariate continuous sensor curves from the arbitrary multivariate sensor data with irregular timestamps, providing feedback to the functional generator to retrain the functional generator.

2. The method of claim 1, wherein the multivariate continuous sensor curves are representative of failure data of the one or more apparatuses.

3. The method of claim 1, wherein the functional generator is configured to apply sparse multivariate functional principal component analysis (FPCA) on the arbitrary multivariate sensor data with irregular timestamps to generate the multivariate continuous sensor curves while maintaining full temporal characteristics of the arbitrary multivariate sensor data with the irregular timestamps.

4. The method of claim 1, wherein the functional discriminator is configured to specify multiple basis projection functions to capture temporal patterns and correlation of the generated multivariate continuous sensor curve and the arbitrary multivariate sensor data with irregular timestamps.

5. The method of claim 4, wherein the functional discriminator is configured to calculate projections based on a linear unbiased estimator for each set of the multiple basis projection functions.

6. The method of claim 1, wherein the functional generator is configured to:
load an estimated continuous temporal pattern of failure data during training of the functional generator into a functional processor;
execute a random noise generator to provide random noise into the functional processor; and
produce synthetic failure data from the functional processor based on the estimated continuous temporal pattern of failure data and the random noise.

7. The method of claim 1, further comprising generating a functional neural network against training the trained functional generator to create a failure prediction model.

8. The method of claim 7, further comprising executing the failure prediction model on the one or more apparatuses to detect real-time failures.

9. A non-transitory computer readable medium, storing instructions for executing a process, the instructions comprising:
executing a functional generator configured to generate multivariate continuous sensor curves from training with arbitrary multivariate sensor data with irregular timestamps received from one or more apparatuses;
executing a functional discriminator to discriminate the generated multivariate continuous sensor curves from the arbitrary multivariate sensor data; and
for the functional discriminator discriminating the generated multivariate continuous sensor curves from the arbitrary multivariate sensor data with irregular timestamps, providing feedback to the functional generator to retrain the functional generator.

10. The non-transitory computer readable medium of claim 9, wherein the multivariate continuous sensor curves are representative of failure data of the one or more apparatuses.

11. The non-transitory computer readable medium of claim 9, wherein the functional generator is configured to apply sparse multivariate functional principal component analysis (FPCA) on the arbitrary multivariate sensor data with irregular timestamps to generate the multivariate continuous sensor curves while maintaining full temporal characteristics of the arbitrary multivariate sensor data with the irregular timestamps.

12. The non-transitory computer readable medium of claim 9, wherein the functional discriminator is configured to specify multiple basis projection functions to capture temporal patterns and correlation of the generated multivariate continuous sensor curve and the arbitrary multivariate sensor data with irregular timestamps.

13. The non-transitory computer readable medium of claim 12, wherein the functional discriminator is configured to calculate projections based on a linear unbiased estimator for each set of the multiple basis projection functions.

14. The non-transitory computer readable medium of claim 9, wherein the functional generator is configured to:
load an estimated continuous temporal pattern of failure data during training of the functional generator into a functional processor;
execute a random noise generator to provide random noise into the functional processor; and
produce synthetic failure data from the functional processor based on the estimated continuous temporal pattern of failure data and the random noise.

15. The non-transitory computer readable medium of claim 9, further comprising generating a functional neural network against training the trained functional generator to create a failure prediction model.

16. The non-transitory computer readable medium of claim 15, further comprising executing the failure prediction model on the one or more apparatuses to detect real-time failures.

17. A management apparatus configured to manage one or more apparatuses, the management apparatus comprising:
a processor configured to:
execute a functional generator configured to generate multivariate continuous sensor curves from training with arbitrary multivariate sensor data with irregular timestamps received from one or more apparatuses;
execute a functional discriminator to discriminate the generated multivariate continuous sensor curves from the arbitrary multivariate sensor data; and
for the functional discriminator discriminating the generated multivariate continuous sensor curves from the arbitrary multivariate sensor data with irregular timestamps, provide feedback to the functional generator to retrain the functional generator.
